(19) United States
(12) Patent Application Publication
(10) Pub. No.: US 2002/0138580 A1
(43) Pub. Date: Sep. 26, 2002

(54) Location based information delivery

(76) Inventors: Binnus Al-Kazily, Star, ID (US); Craig R. White, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/814,301

(22) Filed: Mar. 21, 2001

(51) Int. Cl. G06F 15/16

(52) U.S. Cl. 709/206; 709/245

(57) ABSTRACT

In accordance with this invention, systems and corresponding methods that facilitate the automatic delivery of electronic information to a person based on his geographic location are provided. The system traces the geographic coordinates of a person by establishing a line of communication with a transmitter utilized by the person and delivers any electronic messages for that person to a destination corresponding with the person's coordinates. In one embodiment, a method for delivery of information to a destination in a communications network based on the physical location of a transmitter, includes: determining physical location of a transmitter based on signals transmitted by the transmitter to one or more communications networks; identifying an electronic account in said one or more communications networks based on said signals; determining a communications network address that best matches said physical location; forwarding information relating to said electronic account to said communications network address.

### BACKGROUND

### FIELD OF THE INVENTION

The present invention relates generally to on-line electronic services and, more particularly, to delivery of information to a particular destination in a communications network.

### COPYRIGHT & TRADEMARK NOTICE

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed to limit the scope of this invention to material associated with such marks.

### RELEATED ART

In recent years, cellular technology and electronic mail (email) have provided and become the most popular and convenient means of communication. Cellular telephones allow a person to receive telephone calls almost anywhere within a cellular network provided that the receiver unit is within a range to receive the communication signals. An email address provides an individual with a single universal contact address for sending electronic messages. Further, a person can retrieve electronic messages forwarded to the email address by accessing the email server where the messages are stored.

Typically, in order to access the email server a person would need to interact with a computing system, such as a personal computer, to log-on to the email server and to retrieve and view the messages. A computing system may not always be readily available. Further, a person may like to print the messages and therefore he or she will also need to have access to a printer. For a frequent traveler, carrying a computer and a printer to retrieve and print email messages is not desirable.

It would be very useful, if a person could receive electronic messages at any location without the necessity of directly interacting with a computer system to logon into his or her account and retrieve messages. For example, it is desirable for a traveler to receive electronic messages in a hotel room where the traveler is staying. Current technologies allow an email user to forward his or her messages to a different email address. However, there are no systems or methods available today that automatically determine the physical location of a user and forward electronic messages to a system where the user can retrieve his or her messages.

### SUMMARY

The present disclosure is directed to a system and corresponding methods that facilitate the automatic delivery of electronic information to a person based on his geographic location. The system traces the geographic coordinates of a person by establishing a line of communication with a transmitter (e.g., a cellular phone) utilized by the person and delivers any electronic messages for that person to a destination corresponding with the persons coordinates.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for delivery of information to a destination in a communications network based on the physical location of a transmitter, includes: determining physical location of a transmitter based on signals transmitted by the transmitter to one or more communications networks; identifying an electronic account in said one or more communications networks based on said signals; determining a communications network address that best matches said physical location; forwarding information relating to said electronic account to said communications network address.

In another embodiment, a method for delivery of information to a destination in a communications network based on the physical location of a transmitter, includes: determining physical location of a transmitter based on signals transmitted by the transmitter to a first network; submitting a request to a second network to forward information relating to an electronic account to a communications network address, the electronic account and the communications network address being determined based on said signals; in response to the request, forwarding information relating to the electronic account to the communications network address; delivering the information forwarded to the communications network address to a point of delivery. In certain embodiments, the communications network address is determined by finding the best match between the network addresses available at or near the physical location. The point of delivery can be a printer server, a computer terminal, or a TV screen in a hotel, for example.

In yet another embodiment, a system for delivering electronic information to an address in a computer network, based on the physical location of a cellular transmitter, includes: logic code configured for execution by a processor, wherein execution of the code can cause the system to perform the following acts: determine the physical location of a cellular transmitter based on signals transmitted by the transmitter; identify an electronic account based on said signals; locate a network address that best matches the physical location; submit a request to a server servicing the electronic account to forward electronic information stored on the server for the account to the network address; said server in response to receiving the request forwards the requested information to the network address.

In still another embodiment, a system for delivery of information to a destination in a communications network based on the physical location of a transmitter, includes: a means for determining physical location of a transmitter based on signals transmitted by the transmitter to a first communications network; a means for identifying an electronic account in a second communications network based on said signals; a means for determining a communications network address that best matches said physical location; and a means for forwarding information relating to said electronic account to said communications network address.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

FIG. 1 is a block diagram illustrating a networked environment in which the system of the present invention may operate.

FIGS. 2A and 2B are block diagrams of hardware and software environments in which the system of the present invention may operate.

FIG. 3 is a flow diagram of a method for delivery of information to a destination in a communications network based on the physical location of a transmitter, in accordance with one or more embodiments of the system.

### DETAILED DESCRIPTION

An information delivery system and corresponding methods, according to an embodiment of the present invention, facilitate and provide online electronic services for forwarding information to a specific address in a communication network based on signals received from a mobile transmitter communicating with a communication network.

Electronic services, services, and online services are used interchangeably herein. The online services provided by the system of this invention, in one or more embodiments, are provided by an on-line service provider. A service provider is an entity that operates and maintains the computing systems and environment, such as server system and architectures, that enable the delivery of information. Typically, a server architecture includes the infrastructure (e.g., hardware, software, and communication lines) that stores and offers the electronic or online services.

In the following, numerous specific details are set forth to provide a thorough description of various embodiments of the invention. It is apparent, however, to one skilled in the art that certain embodiments of the invention may be practiced without these specific details or with some variations in detail.

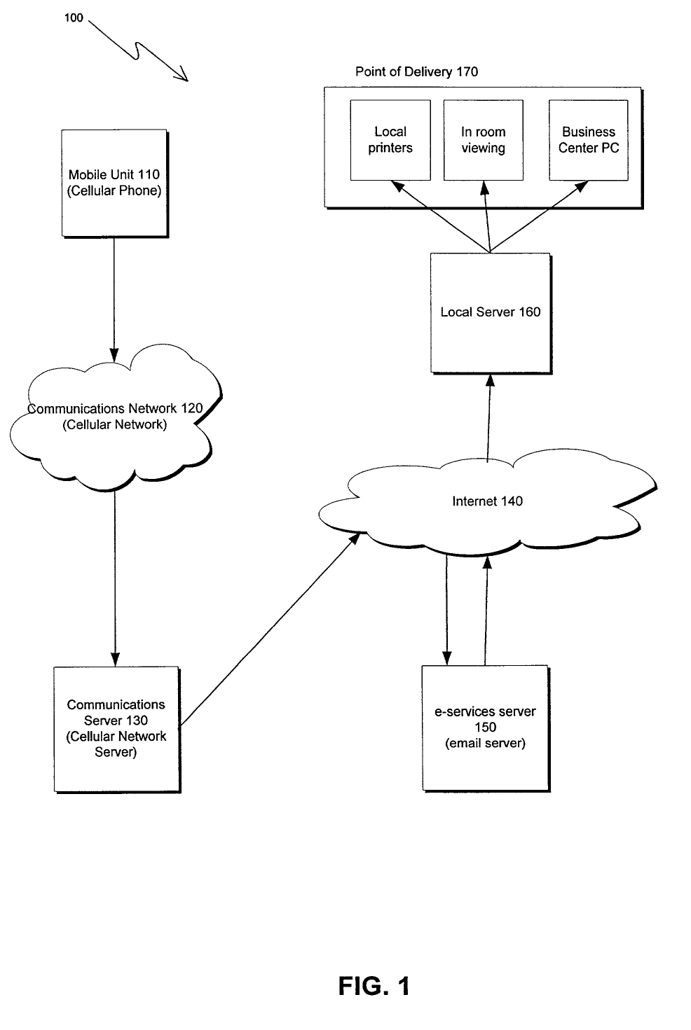

Embodiments of the present invention are understood by referring to FIGS. 1-3 of the drawings. Throughout the drawings, components that correspond to components shown in previous figures are indicated using the same reference numbers.

Nomenclature

The detailed description that follows is presented largely in terms of processes and symbolic representations of operations performed by conventional computers, including computer components. A computer may be any microprocessor or processor (hereinafter referred to as processor) controlled device such as, by way of example, personal computers, workstations, servers, clients, mini-computers, mainframe computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, or any combination thereof. The computer may possess input devices such as, by way of example, a keyboard, a keypad, a mouse, a microphone, or a touch screen, and output devices such as a computer screen, printer, or a speaker. Additionally, the computer includes memory such as a memory storage device or an addressable storage medium. The computer may be equipped with a network communication device such as a network interface card, a modem, or other network connection device suitable for connecting to one or more networks.

The computer may be a uniprocessor or multiprocessor machine. Additionally the computer, and the computer memory, may advantageously contain program logic or other substrate configuration representing data and instructions, which cause the computer to operate in a specific and predefined manner. The program logic may advantageously be implemented as one or more modules. The modules may advantageously be configured to reside on the computer memory and execute on one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art. The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like. These tasks should not be confused with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as, by way of example, read-only memory (ROM).

System Architecture

Referring now to the drawings, FIG. 1 illustrates an environment in which an information delivery system 100 according to one embodiment may operate. In accordance with one aspect of the system, the environment includes communications server 130, an e-services server 150, and a local server 160 for providing electronic services (e.g., delivering email messages) to a point of delivery 170. As depicted, communications server 130, e-services server 150, and local server 160, are connected to a communication network, such as the Internet 140. The terms “connected,” “coupled,” or any variant thereof, mean any connection or coupling, either direct or indirect, between two or more elements. The coupling or connection between the elements can be physical, logical, or a combination thereof.

Communications server 130 communicates with a mobile unit 110 via a communications network 120. The communications network 120 provides the medium for transmitting digital or analog signals between communications server 130 and mobile unit 110. Based on the signals transmitted by mobile unit 110, the physical location of mobile unit 110 (or a person using it) can be determined, in a well-known manner. In certain embodiments, the mobile unit is a cellular telephone and communications network 120 is a cellular network, for example. Mobile unit 110 and communications network 120, however, may be based on any type of wired or wireless communication technology (e.g., radio, radar, etc.).

E-services server 150 communicates with communications server 130 and local server 160 via the Internet 140. E-services server 150 processes the requests forwarded by communications server 130 and forwards the requested results to local server 160. In certain embodiments, e-services server 150 is an email server that forwards requested email messages to a network address (e.g., IP address) specified in the request. E-services server 150, however, can provide any type of electronic service to a specified destination, in accordance with other aspects of the system. That is, the e-services in addition to email services may provide imaging, financial, media, and other web content delivery services. For example, embodiments of the system may be utilized to deliver pictures, stock quotes, and news articles to specific destinations.

Local server 160 is the computing system that communicates with e-services server 150 to provide a user with access to services available on e-services server 150. Local server 160 is at or near the physical location where mobile unit 110 is located. The location of local server 160 is thus selected and changes based on the physical location of mobile unit 110 at the time the request for access to services available on e-services server is submitted. Depending on the type of service provided, the information forwarded from e-services server 150 to local server 160 may be further processed and transmitted to a point of delivery 170. For example, if a user is staying in a hotel room, system 100 may be utilized to deliver to the user his or her email messages at the television set available in the room. Alternatively, the messages may be delivered to a printer or a computer system in the hotel's business center.

The Internet 140, in a well-known manner, connects millions of computers world wide through standard common addressing systems and communications protocols (e.g., Transmission Control Protocol/Internet Protocol (TCP/IP), HyperText Transport Protocol (HTTP)) creating a vast communications network. Information on the Internet is stored worldwide as computer files (e.g., Hypertext Mark Up Language (HTML) files). These computer files are stored at various web servers attached to the Internet 140, and are commonly referred to as web pages. The collection of said web pages is known as the World Wide Web (WWW). A standard naming convention known as Uniform Resource Locator (URL) has been adopted to represent links and provide access to said web pages and services provided there on.

Some of the e-services provided by information delivery system 100 may be accessed by application software, such as a browser. The browser is a software program that allows the user to connect to the Internet 140 and parse web pages available on the system by referencing their URL. In one embodiment, the browser may be a standard browser such as the Netscape Navigator® developed by Netscape, Inc., Mountain View, Calif., (www.netscape.com), the Microsoft Internet Explorer® developed by Microsoft Corporation, Redmond, Wash. (www.microsoft.com), a WebTV, an embedded web browser on a handheld device, or the like. In another embodiment, other types of access software, such as, by way of example, custom network browsers, communication software, cable modem software, point-to-point software, multi-point software, custom emulation software, and the like, can be used.

One of ordinary skill in the art will appreciate that the Internet 140 and communication network 120 may advantageously be comprised of one or a combination of other types of networks without detracting from the scope of the invention. The Internet 140 can include, for example, local area networks (LANs), wide area networks (WANs), public internets, private intranets, a private computer network, a secure internet, a private network, a public network, a value-added network, interactive television networks, wireless data transmission networks, two-way cable networks, satellite networks, interactive kiosk networks, and/or any other suitable communications network.

As used herein, the terms email delivery system, communications server, e-services server, and local server are to be viewed as designations of one or more computing systems that include server software for servicing requests submitted by client software included in devices or other computing systems connected to the Internet 140 and communication network 120. These terms are not to be otherwise limiting in any manner. The server software and client software, for example, may be comprised of one or more modules that execute on one or more computing systems, as described in further detail below.

Hardware & Software Environments

As described in further detail below, typically, a computing system is composed of two environments, a software environment and a hardware environment. The hardware environment includes the machinery and equipment that provide an execution environment for the software. On the other hand, the software provides the execution instructions for the hardware.

In operation, a computing system needs both hardware and software to function. The software can be divided into two major classes including system software and application software. System software includes control programs, such as the operating system (OS) and information management systems that instruct the hardware how to function and process information. An example of system software is Microsoft Windows 2000® operating system generally used for managing the operation of personal computers.

Application software is a program that performs a specific task. In embodiments of the invention, system and application software are implemented and executed on one or more hardware environments to determine the physical location of mobile unit 110 based on signals transmitted by mobile unit 110 to communications server 130; to identify an electronic account based on said signals; to determine local server 160 that best matches said physical location; and to forward information relating to said electronic account to local server 160.

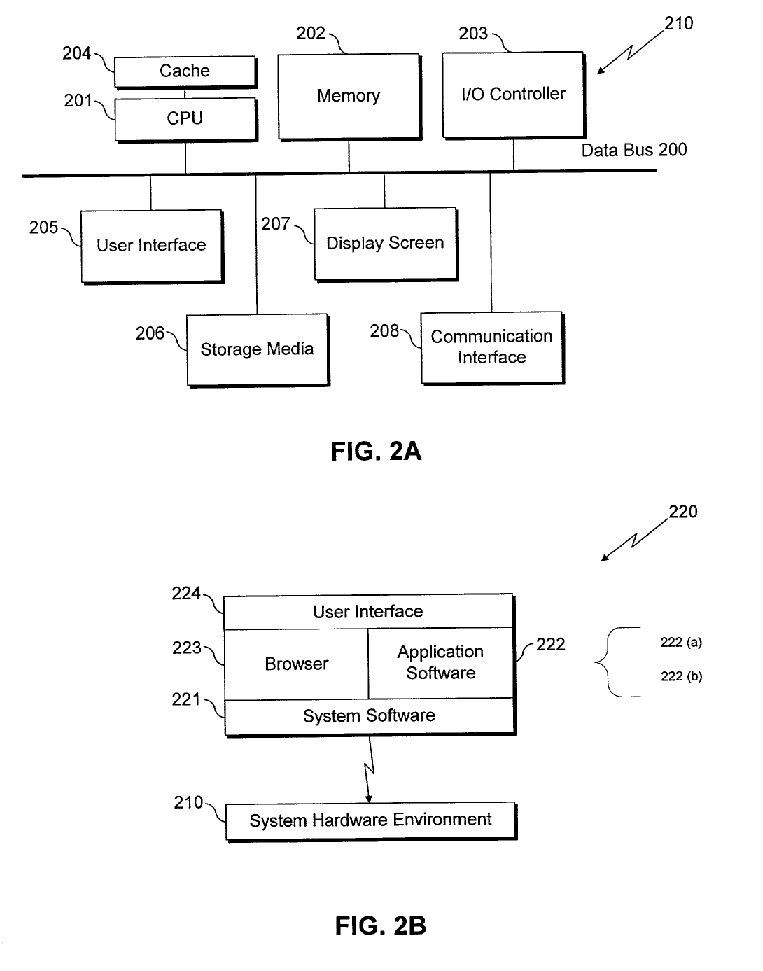

The invention may be practiced either individually or in combination with suitable hardware or software architectures or environments described in further detail below. For example, mobile unit 110, communications system 130, e-services server 150, and local server 160 may be implemented in association with computing system 210 (FIG. 2A). Client and server software running on the above systems, including application software for delivering information to a point of delivery based on physical location of a mobile unit may be implemented in association with one or multiple modules as software system 220 (FIG. 2B). The following hardware and software embodiments are provided by way of example. It should be noted that certain hardware and software component may be interchangeably implemented in form of software or hardware, in one or more embodiments of the invention.

Hardware Environment

An embodiment of the system can be implemented as computer software in the form of computer readable code executed on a general purpose computing system 210, in accordance with one or more aspects of the invention. FIG. 2A illustrates an example of the components of computing system 210. Computing system 210 includes a central processor unit (CPU) 201, a main memory 202, an input/output controller 203, optional cache memory 204, user interface devices 205 (e.g., keyboard, pointing device, etc.), storage media 206 (e.g., hard drive, memory, etc.), a display screen 207, a communication interface 208 (e.g., a network card, a modem, or an integrated services digital network (ISDN) card, etc.), and a system synchronizer (e.g., a clock, not shown in FIG. 2A).

Processor 201 may or may not include cache memory 204 utilized for storing frequently accessed information. One or more input/output devices such as a printing or a scanning device may be attached to computing system 210. A communication mechanism, such as a bidirectional data bus 200, can be utilized to provide for means of communication between system components. Computing system 210 may be capable of communicating with one another and other systems through communication interface 208.

In one or more embodiments, computing system 210 may not include all the above components, or may include additional components for additional functionality or utility. For example, computing system 210 can be a laptop computer or other portable computing device that can send messages and receive data through communication interface 208. Computing system 210 may also be embodied in an embedded system such as a set-top box, a personal data assistant (PDA), a wireless communication unit (e.g., cellular phone), or other similar hardware platforms that have information processing and/or data storage and communication capabilities.

For example, in embodiments of the system mobile unit 110 may be a smart card that could be inserted into a reading unit attached to the Internet 140 in order to transmit location and account information to e-services server 150. A smart card is a credit card size card with a built-in microprocessor and memory used for identification or financial transactions. When inserted into a reader, it transfers data to and from a central computer.

In embodiments of the system, communication interface 208 can send and receive electrical, electromagnetic, or optical signals that carry digital data streams representing various types of information including program code. If communication is established via the Internet 140, computing system 210 may transmit program code through an Internet connection. The program code can be executed by central processor unit 201 or is stored in storage media 206 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 201 is a microprocessor manufactured by Motorola, Intel, or Sun Microsystems Corporations. The named processors are for the purpose of example only. Any other suitable microprocessor, microcontroller, or microcomputer may be utilized.

Software Environment

FIG. 2B illustrates computer software 220 suited for managing and directing the operation of the hardware environment described above. Computer software 220 is, typically, stored in storage media 206 and is loaded into memory 202 prior to execution. Computer software 220 includes system software 221 and application software 222. Depending on system implementation, certain aspects of computer software 220 can be stored and loaded on one or more computing systems.

System software 221 includes control software such as an operating system that controls the low-level operations of computing system 210. Low-level operations include the management of the system's resources such as memory allocation, file swapping, and other core computing tasks. In one or more embodiments of the invention, the operating system is Microsoft Windows CE®, Microsoft Windows NT®t, Macintosh OS®, or IBM OS/2®. However, any other suitable operating system may be utilized.

Application software 222 can include one or more computer programs that are executed on top of system software 221 after being loaded from storage media 206 into memory 202. In a client-server architecture, application software 222 may include a client software 222(a) and a server software 222(b). Referring to FIG. 1 for example, in one embodiment of the invention, client software 222(a) is executed on mobile unit 110 and server software 222(b) is executed on servers 130, 150, and 160.

Computer software 220 may also include web browser software 223 for communicating with the Internet. Further, computer software 220 includes a user interface 224 (e.g., a Graphical User Interface (GUI)) for receiving user commands and data. The commands and data received are processed by the software applications that run on the computing system 210. The hardware and software architectures and environments described above are for purposes of example only. Embodiments of the invention may be implemented in any type of system architecture or processing environment.

Application Software for Delivering Email Messages to a Point of Delivery

Embodiments of the invention are described by way of example as applicable to a system and corresponding methods that facilitate the delivery of electronic mail messages to a user. In this examplary embodiment, the application software is implemented to detect the physical location of an individual in a cellular network and to deliver electronic email messages to that individual.

Thus, to describe this examplary embodiment, references are made to cellular phone 110, cellular network 120, cellular network server 130, and email server 150, instead of mobile unit 110, communications network 120, communications server 130, and e-services server 150, respectively. It should be noted, however, that this examplary embodiment is not to be construed to limit the scope of the invention only to delivery of electronic mail messages and/or utilization of cellular technology. The invention, in various embodiments, may be applied and implemented in any environment that supports delivery of any type of electronic information or services, using any communication technology.

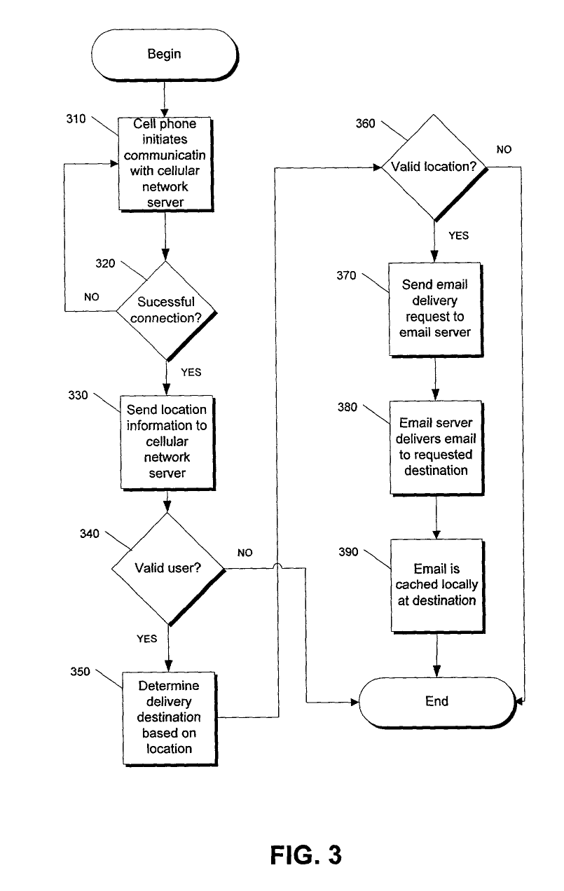

Referring to FIGS. 1 and 3, in accordance with one aspect of the invention at step 310, a user using cellular telephone 110 initiates communication with cellular network server 130. The communication can be initiated either automatically or by the user. For example, the user can dial a code or program cellular phone 110 to establish a connection with cellular network server 130. At step 320, if the connection is not successful, the user using cellular phone 110 tries again to establish a connection by reverting back to step 310. The connection may also be established based on certain user triggered events. For example, if the user uses his phone to check into a hotel, then the connection may be established at the time of occurrence of the check-in event.

In one or more embodiments, packet switching technology, such as “imode,” may be utilized to automatically and periodically monitor the location of cellular phone 110 without the need for user initiated action to establish communication between cell phone 110 and cellular network server 130. imode is a mobile internet access system developed by NTT DoCoMo, Japan that is based on packet switched technology rather than circuit switched technology currently used in most cellular networks. To establish a connection, in a circuit switched network, a user needs to initiate communication with the network by dialing a phone number, for example. In a packet switched network, a connection is permanently established between the phone unit and the network. In a packet switched network, a connection may be initiated and established either by the phone unit or a network transmitter.

Typically, a connection can be successfully established if cellular phone 110 is within a service area covered by cellular network 120. If the communication is successfully established, then at step 330, cellular phone 110 forwards to cellular network server 130 information (e.g., signals) that can be used to determine the physical location of cellular phone 110 within cellular network 120. Signals transmitted by cellular phone 110 to cellular network server 130 are processed in a manner well-known to those skilled in the art to determine the physical location of cellular phone 110 or its user. Alternatively, a global positioning system (e.g., GPS) may be implemented in the system to determine location information. The location information can include geographic coordinates of cellular phone 110, for example.

The communication signals transmitted by cellular phone 110 may also include identifying information to identify one or more user accounts established on one or more servers, such as cellular network server 130 and email server 150. For example, a user may have an account on the cellular network server 130, and also a separate email account on email server 150. Thus, at step 340, it is determined whether the identifying information submitted can be processed to identify a valid user or account on either of the two servers.

The communication signals transmitted by cellular phone 110 may further include commands to request for email messages for the identified accounts to be forwarded to a destination, such as local server 160. Local server 160 is attached to the Internet 140. To forward the messages to local server 160 it is required to find its Internet Protocol (IP) address. The IP address of a computer is the logical address by which it is recognized on a TCP/IP network, such as the Internet 140. In a computer network, every client and server station has a unique IP address that is either permanently or dynamically assigned. IP addresses are written as four sets of numbers separated by periods, for example, 204.171.64.2.

As step 350, the delivery destination (i.e., the network or the IP address) is determined based on the physical location of cellular phone 110 at the time of transmission of the communication signals. The network address for local server 160 can be, for example, determined based on mapping the location information against a destination database that includes the network address for available servers within cellular network 120. This database, for example, may be implemented such that one or more destination addresses are associated with a definable geographic location, such as a street address or the name of a prominent landmark or structure. The destination that best matches the location information is thus chosen as the destination address. At step 360, it is determined whether the selected destination address is a valid destination, if possible.

At step 370, cellular network server 130 forwards an email delivery request including user account and destination information to email server 150. Email server 150, for example, can include a file system that stores email messages for the user. Based on user account and destination information submitted within the request, email server 150 forwards any email messages for the user to local server 160, at step 380. In one or more embodiments of the system, steps 340 through 360 that involve finding and determining the validity of a user account or destination based on information transmitted by cellular phone 110 are performed by application software executing on email server 150.

Once the email messages are received at local server 160, the messages are cached locally and are made available for viewing, at step 390. In certain embodiments, local server 160 is attached to a local network. Various devices such as television sets, printers, or computer terminals may be attached and serviced by local server 160. For example, local server 160 may be located in a hotel where the user is staying. Thus, at the request of the user, local server 160 may be configured to forward messages received for the user to a point of delivery 170 within the local network.

In one embodiment, the messages are, for example, transmitted to a television set attached to the local network, placed in the room reserved for the user. As such, the user can view his or her messages by simply interacting with available menu systems made available on the television set. In other embodiments, the email messages are printed on a printer attached to the local server as they arrive or as requested by the user. Other alternatives, include providing the email messages available for viewing on a computer in the hotel's business center, for example. The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method for delivery of information to a destination in a communications network based on the physical location of a transmitter, comprising:
determining physical location of a transmitter based on signals transmitted by the transmitter to one or more communications networks;
identifying an electronic account in said one or more communications networks based on said signals;
determining a communications network address that best matches said physical location;
forwarding information relating to said electronic account to said communications network address.

2. The method of claim 1, wherein signals transmitted by the transmitter are forwarded to a first communications network.

3. The method of claim 2, wherein the electronic account is identified in a second communications network.

4. The method of claim 3, wherein the information forwarded includes electronic mail messages associated with the electronic account.

5. A method for delivery of information to a destination in a communications network based on the physical location of a mobile unit, comprising:
determining physical location of a mobile unit based on signals transmitted by the mobile unit to a first communications network;
submitting a request to a second communications network to forward information relating to an electronic account to a network address; the electronic account and the network address being determined based on said signals.

6. The method of claim 5, further comprising:
in response to the request, forwarding information relating to the electronic account to the network address.

7. The method of claim 6, further comprising:
delivering the information forwarded to the network address to a point of delivery.

8. The method of claim 5, wherein the first communications network is a cellular network.

9. The method of claim 8, wherein the mobile unit is a cellular telephone.

10. The method of claim 5, wherein the second communications network is a computer network.

11. The method of claim 10, wherein the computer network includes a server for servicing the submitted request for the electronic account.

12. The method of claim 11, wherein the server is an electronic mail server.

13. The method of claim 10, wherein the network address is determined by finding the best match between the network addresses available at or near the physical location.

14. The method of claim 13, wherein the network address is the IP address of a server at or near the physical location.

15. The method of claim 6, wherein the information forwarded includes electronic mail messages for the electronic account.

16. The method of claim 7, wherein the point of delivery is a printer server.

17. The method of claim 7, wherein the point of delivery is a device that can display the information.

18. A system for delivering electronic information to an address in a computer network, based on the physical location of a cellular transmitter, said system comprising:
logic code configured for execution by a processor, wherein execution of the code can cause the system to perform the following acts:
determine the physical location of a cellular transmitter based on signals transmitted by the transmitter;
identify an electronic account based on said signals;
locate a network address that best matches the physical location;
submit a request to a server servicing the electronic account to forward electronic information stored on the server for the account to the network address.

19. The system of claim 18, wherein said server in response to receiving the request forwards the requested information to the network address.

20. The system of claim 19, wherein said requested information includes electronic messages.
